(19) United States
(12) Patent Application Publication
(10) Pub. No.: US 2024/0123421 A1
(43) Pub. Date: Apr. 18, 2024

(54) Reactor for Carrying Out a Chemical Reaction in a Process Fluid and Method

(71) Applicants: Linde GmbH, Pullach (DE); BASF SE, Ludwigshafen (DE)

(72) Inventors: Mathieu Zellhuber, Martinsried (DE); Martin Hofstatter, München (DE); Heinz Posselt, Bad Aibling (DE); Clara Delhomme-Neudecker, München (DE); Dieter Mihailowitsch, Geretsried (DE)

(21) Appl. No.: 18/264,697

(22) PCT Filed: Feb. 7, 2022
(86) PCT No.: PCT/EP2022/052913

§ 371 Date: Aug. 8, 2023

(30) Foreign Application Priority Data
Feb. 11, 2021 (EP) 21156666.6

(51) Int. Cl. B01J 19/24

(52) U.S. Cl. CPC B01J 19/2425; B01J 2219/00121; B01J 2219/00135

(57) ABSTRACT

A reactor for carrying out a chemical reaction using multiphase alternating current, includes a reactor chamber surrounded by thermally insulating reactor walls and multiple substantially straight reaction tubes. The reaction tubes run between at least one tube inlet opening and at least one tube outlet opening in opposite reactor walls and consist of a material that permits electrical resistance heating. Two electrically conductive bridges spaced apart along the reaction tubes are provided, each of which electrically conductively connects the reaction tubes to one another. Electrically conductive power input arrangements are provided extending through one or more input openings in one of the reactor walls. Each reaction tube is electrically conductively connected to one of the power input arrangements. Each power input arrangement is electrically conductively connected between the bridges to one of the reaction tubes and is connected or connectable to one of the phases of the alternating current.

### CROSS-REFERENCE TO RELATED APPLICATIONS

This application is the national phase of, and claims priority to, International Application No. PCT/EP2022/052913, filed Feb. 7, 2022, which claims priority to European Patent Application No. 21156666.6, filed Feb. 11, 2021.

### FIELD OF THE INVENTION

The invention relates to a reactor for carrying out a chemical reaction in a process fluid using multiphase alternating current in order to heat the process fluid.

### BACKGROUND

In a series of processes in the chemical industry, reactors are used in which one or more reactants are conducted through heated reaction tubes and are catalytically or non-catalytically converted there. The heating serves in particular to overcome the activation energy requirement for the chemical reaction taking place. The reaction can proceed endothermically overall or exothermically after overcoming the activation energy requirement. The claimed invention relates in particular to strongly endothermic reactions.

Examples of such processes are steam cracking, different reforming processes, in particular steam reforming, dry reforming (carbon dioxide reforming), mixed reforming processes, processes for dehydrogenating alkanes and the like. In steam cracking, the reaction tubes are guided through the reactor in the form of tube coils, which have at least one U-bend in the reactor, whereas tubes which typically extend through the reactor without U-bends are used in steam reforming.

The invention is suitable for all such processes and embodiments of reaction tubes. Purely for illustration purposes, reference is made here to the articles “Ethylene,” “Gas Production,” and “Propene” in Ullmann's Encyclopedia of Industrial Chemistry, for example the publications from Apr. 15, 2009, DOI: 10.1002/14356007.a10_045.pub2, from Dec. 15, 2006, DOI: 10.1002/14356007.a12_169.pub2, and from Jun. 15, 2000, DOI: 10.1002/14356007.a22_211.

The reaction tubes of corresponding reactors are conventionally heated by using burners. The reaction tubes are guided through a combustion chamber in which the burners are also arranged.

Currently, the demand for synthesis gas and hydrogen, which are produced without or with reduced local carbon dioxide emissions, is rising. However, methods in which fired reactors are used cannot meet this demand or can meet it only to a limited extent due to the burning typically of fossil fuels. Other processes are rejected due to high costs, for example. The same also applies to the provision of olefins and/or other hydrocarbons by steam-cracking or dehydrogenating alkanes. In such cases too, there is a desire for processes which emit lower amounts of carbon dioxide at least on site.

EP 3075704 A1 discloses a furnace for steam reforming with reaction tubes guided through a combustion chamber, wherein, in addition to at least one burner, an electrical resistance heating of the reaction tubes is provided by means of alternating current, wherein a collector located outside the combustion chamber serves as a star point. U.S. Pat. No. 9,347,596 B2 relates to a device for electrically heating a pipeline system.

WO 2015/197181 A1 discloses a reactor in which a fluid flowing through a pipeline is heated, wherein the electrically conductive pipeline is connected to multiple phases of an alternating current source such that a star point circuit is formed and heat is generated according to the electrical resistance of the pipeline. The arrangement shown there is particularly suitable for so-called multi-pass tube geometries, i.e., the pipelines run back and forth in a wavy line.

However, in the case of single-pass tube geometries, in which the pipelines to be heated run in a straight line through the reactor, boundary conditions, in particular those of an electrical and thermal nature, cannot be met with these known or similar arrangements. The object is therefore to provide an electrically heatable reactor by means of which electrical, thermal, and mechanical boundary conditions can be met.

### SUMMARY

According to an embodiment of the invention, a reactor for carrying out a chemical reaction proceeding at least in part at a temperature of at least 500° C. in a process fluid using multiphase alternating current includes a reactor chamber surrounded by thermally insulating reactor walls; and multiple substantially straight reaction tubes. The reaction tubes run between at least one tube inlet opening and at least one tube outlet opening in opposite reactor walls through the reactor chamber and consist of a material that permits electrical resistance heating. Two electrically conductive bridges, which are spaced apart from one another along the reaction tubes, are provided in the reactor chamber. Each of the conductive bridges electrically conductively connects the reaction tubes to one another. Electrically conductive power input arrangements are provided extending through one or more input openings in one of the reactor walls. Each reaction tube is electrically conductively connected to one of the power input arrangements. Each power input arrangement is electrically conductively connected between the bridges to one of the reaction tubes and is connected or connectable to one of the phases of the alternating current.

### BRIEF DESCRIPTION OF THE DRAWINGS

FIG. 1 shows a reactor connected to an alternating current source according to a preferred embodiment of the invention;

FIGS. 2A and 2B show cross sections of one-piece bridges and their connection to reaction tubes according to preferred embodiments of the invention;

FIG. 3 shows a cross section of a multipart bridge according to a further preferred embodiment of the invention;

FIG. 4 shows schematically a power input arrangement according to an embodiment of the invention; and

FIGS. 5A and 5B schematically show reactors in which, according to a preferred embodiment, cooling panels are provided for cooling the power input arrangements.

### DETAILED DESCRIPTION OF THE INVENTION

According to the invention, it is provided that the power input into the reaction tubes, which are to be heated, be carried out between the electrically conductive bridges; bridges, which connect the reaction tubes in an electrically conductive manner, are therefore arranged on both sides of the power input. A potential equalization between the phases takes place via the electrically conductive bridges so that electrical current flows from the reaction tubes via further process lines into other parts of a process plant, in which the reactor is installed and which can cause damage or hazards there, are prevented or strongly suppressed. The arrangement of bridges on both sides means that this takes place both on the inlet side and on the outlet side. In the case of single-pass tube geometries, this has an advantage over an arrangement with only one bridge, since with such an arrangement a cost-intensive electrical insulation of the reaction tubes of the further process lines would otherwise have to be provided on one side.

At the same time, the power input arrangements are spaced apart from the tube inlet and tube outlet openings by means of the arrangement according to the invention, so that cooling elements can be attached to the power input arrangements which, in relation to the application, have to conduct high currents, without there being conflicts with continuing process lines relating to space, in particular hot reaction tubes or further process lines connected thereto cannot negatively influence the cooling capacity of such cooling elements. Also, in relation to the mechanical construction, there are no conflicts relating to space between the power input arrangements, which, due to the high currents occurring, comprise solid live elements, and further process lines.

In detail, a reactor for carrying out a chemical reaction in a process fluid using multiphase alternating current is provided. The reactor comprises a reactor chamber surrounded by thermally insulating reactor walls and multiple substantially linear reaction tubes. The alternating current serves for the electrical heating of the reaction tubes and thus of the process fluid flowing through the reaction tubes so that said process fluid is provided with energy for the chemical reaction. The fact that the reaction tubes and thus the process fluid are heated using alternating current is not intended to exclude that additional heating can be provided, for example by firing chemical energy carriers. The chemical reaction is a chemical reaction which proceeds at least in part at at least 500° C.

The reaction tubes run between at least one tube inlet opening and at least one tube outlet opening in opposite reactor walls through the reactor chamber and consist of a material which enables electrical resistance heating. The fact that the reaction tubes or the material thereof are electrically heatable means that the material used for the reaction tubes and in particular the sections between the bridges is a material with an electrical conductivity suitable for electrical heating. Examples are heat-resistant steel alloys, in particular heat-resistant chromium-nickel steel alloys. Such steel alloys can also be used for the bridges and the power input arrangements, in particular the live elements thereof. For example, materials with the standard designations, GX40CrNiSi25-20, GX40NiCrSiNb35-25, GX45NiCrSiNbTi35-25, GX35CrNiSiNb24-24, GX45NiCrSi35-25, GX43NiCrWSi35-25-4, GX10NiCrNb32-20, GX50CrNiSi30-30, G-NiCr28 W, G-NiCrCoW, GX45NiCrSiNb45-35, GX13NiCrNb45-35, GX13NiCrNb37-25, or GX55NiCrWZr33-30-04 according to DIN EN 10027, Part 1, “Materials,” may be used. Material No. 1.4852 or No. 1.4852 Micro (GX40NiCrSiNb35-26) is particularly suitable.

In the reactor chamber, two electrically conductive bridges are provided spaced apart from one another along the reaction tubes, each of said electrically conductive bridges electrically conductively connecting the reaction tubes to one another. Electrically conductive power input arrangements are provided which extend through one or more input openings (or power input openings) in one of the reactor walls, wherein each power input arrangement is electrically conductively connected between the bridges to one of the reaction tubes and is connected or can be connected to one of the phases of the alternating current. The electrically conductive connections (power input point or contact point) of the power input arrangements to the reaction tubes thus lie within the reaction chamber, as do the bridges. Each reaction tube is connected in an electrically conductive manner to one of the power input arrangements.

The expression “substantially straight” refers on the one hand to the fact that inlet or outlet manifolds (so-called headers) can be provided in the reactor chamber, between a bridge and the closest reactor wall in which a tube inlet or tube outlet opening is located, which inlet or outlet manifolds connect several reaction tubes to from a single manifold. On the other hand, slight deviations from a straight line can occur between the bridges, i.e., each reaction tube should run between the bridges within a circular cylinder having 10 times the diameter of the reaction tube.

The reactor walls enclose or surround the reactor chamber, i.e., a region which is delimited in all spatial directions by at least one reactor wall. The reactor chamber is typically inertized. In general, multiple individual walls are used for this purpose, which are joined in such a way that they enclose the reactor chamber; it could therefore also be referred to as a group of reactor walls. The enclosed region, and hence the group of reactor walls, can have any volumetric shape, but preferably that of a square prism or even of a cylinder. The reactor walls can have sealed structural elements (such as feedthroughs or windows), but also permanently open and/or closable openings as a connection to other plant parts, preferably for conditioning the atmosphere within the reactor wall, e.g., inlet nozzle for inert gas or outlet opening to form a chimney tract.

Preferably, an electrical resistance of each of the bridges between two reaction tubes (i.e., the electrical resistance between two reaction tubes measured over the respective bridge) is less than an electrical comparator resistance; wherein the comparator resistance is equal to the electrical resistance (in the longitudinal direction of the reaction tubes) of one of the reaction tubes over a comparative length; wherein comparative length is selected from: a distance of the two reaction tubes, a length of a reaction tube connection between an inlet and outlet header and a bridge connection at the inlet or outlet of the tube (i.e., the length of the reaction tube connection corresponds to the distance between bridge and inlet or outlet header). It is also conceivable to select a dimension of the bridge in the longitudinal direction (of the reaction tubes) as a comparison length. Combinations of these selection options for the comparison length are also possible, for example by averaging or totaling. Further preferably, a ratio of the electrical resistance of the bridge (between the two reaction tubes) to the comparator resistance is at most 1/10, even more preferably at most 1/50, most preferably at most 1/100. In particular, this results in the electrical resistance of the bridges being smaller than the electrical resistance of further process lines or inlet and outlet headers, which, due to the relatively high temperatures still prevailing there, typically consist of the same or a similar material (in particular a steel) as the reaction tubes and have correspondingly comparable electrical conductivities. The effect thereof is that the potential equalization and currents occurring between the phases are largely effected or flow over the bridges and only small or no currents flow into further process lines outside the reactor. The comparator resistance corresponds to the electrical resistance of a section (comparison section) of a reaction tube having a length equal to the comparative length. Since the multiple reaction tubes typically has the same dimensions (inner, outer diameter) and consists of the same material, the comparator resistance is independent of which reaction tube is used to determine the comparator resistance. The comparator resistance can be calculated easily and/or measured.

Preferably, the bridges are made of the same material as the reaction tubes. Thus, the reaction tubes can be connected to one another in a heat-resistant manner via the bridges, in particular by welding. Alternatively, the bridges are made of a material with higher electrical conductivity than the reaction tubes. Also preferred is a cross-sectional area of the bridges, which lies between two reaction tubes, runs parallel to the reaction tubes and is perpendicular to the plane formed by the two reaction tubes, greater than a cross-sectional area of a wall of the reaction tubes that is perpendicular to the longitudinal axis of the tube. These embodiments allow permit electrical resistance of the bridges relative to the reaction tubes.

Preferably, the reaction tubes are cast in at least one of the bridges and/or, in each case for at least one of the bridges for each reaction tube, a reaction tube section is formed integrally (in one piece) with the bridge or an element of the bridge, wherein further reaction tube sections are preferably connected to the bridge by welding.

Furthermore, at least one bridge preferably comprises first bridge elements, each of which is electrically conductively connected to one of the reaction tubes, and a second bridge element which electrically conductively connects the first bridge elements, wherein the second bridge element consists of a material which has a higher electrical conductivity than a material of which the first bridge elements are made, wherein preferably the first bridge elements are made of the same material as the reaction tubes.

This embodiment makes it possible to reduce the electrical resistance of the bridges when the geometric dimensions are the same, so that the potential equalization between the reaction tubes is improved. The material of the first bridge elements can be selected such that they can be connected to the reaction tubes in a simple and heat-resistant manner, for example by welding, i.e., the material of the reaction tubes is preferably also used for the first bridge elements.

The second bridge element preferably has passages through which the reaction tubes run and into which the first bridge elements are inserted in the form of a fit, in particular a press fit, wherein further preferably the material of the second bridge element has a lower coefficient of thermal expansion than the material of the first bridge elements. In particular, the material of the second bridge element can comprise molybdenum, tungsten, tantalum, niobium and/or chromium or predominantly consist of one of these materials or a combination thereof. Even more preferably, the second bridge element is predominantly or completely made of molybdenum and/or the first bridge elements are made of the material of the reaction tubes.

In this embodiment, the second bridge element or the second bridge elements consist at least in part of a material which is rich in molybdenum, tungsten, tantalum, niobium and/or chromium or is formed therefrom. The material has in particular a higher specific electrical conductivity than the material from which the first bridge elements are formed.

Due to the fact that the first bridge elements are connected to the second bridge element by means of a press fit, a connection is created which is releasable in principle and which facilitates, for example, the replacement of reaction tubes. As the temperature increases, the different coefficients of thermal expansion result in the press fit taking place with a higher pressure, so that the contact, in particular the electrical contact, between the first and the second bridge element is improved. Molybdenum has, for example, a higher conductivity than steels which are preferably used for the first bridge elements and the reaction tubes, and can simultaneously be used at the high temperatures prevailing in the reactor vessel.

Preferably, the bridges are designed as rigid components or assemblies, wherein further preferably at least one, even more preferably each, of the bridges is designed in one piece, in particular as a cast part. The rigid design leads to an additional relative fixing of the reaction tubes.

The one or more input openings (for electrical connections) are preferably located in a reactor wall which runs between the reactor walls in which the at least one tube inlet opening or the at least one tube outlet opening is located; wherein further preferably the one or more input openings have an elongate form parallel to the longitudinal direction of the reaction tubes. The power input arrangement can thus move with the thermal expansion of the reaction tubes. The reactor wall in which the one or more input openings are located is thus a lateral reactor wall, i.e., a reactor wall extending in the direction of the reaction tubes (e.g., parallel thereto or at an angle, approximately <20°, thereto).

Preferably, cooling panels, which are arranged adjacent to live elements of the power input arrangements, are provided outside the reactor chamber, wherein the cooling panels preferably extend parallel to the longitudinal direction of the reaction tubes. The cooling panels are further preferably accommodated in an (inertized) connection chamber which is arranged on an outer side of the reactor wall in which the input openings are arranged.

Preferably, the one or more input openings are spatially separated from the at least one tube inlet opening and from the at least one tube outlet opening.

According to a preferred embodiment, the reactor comprises an alternating current source or alternating voltage supply which provides the alternating current or an alternating voltage. In particular, for at least one, preferably for all bridges, a neutral conductor can be provided, which connects the bridge to a star point of the alternating current source; further preferably, an electrical resistance of the bridges between two reaction tubes is smaller than the electrical resistance of the neutral conductor connected to the respective bridge, wherein further preferably a ratio of these resistances is at most 1/5, more preferably at most 1/20, most preferably at most 1/50.

Preferably, the electrical resistance of the neutral conductor (between bridge and star point of the alternating current source) is smaller than the electrical comparator resistance. Here, the comparator resistance introduced above in connection with the electrical resistance of the bridges is meant, wherein, if different comparator resistances are defined based on different comparative lengths, one can be selected or an average value of the comparator resistance can be used.

A phase shift between two mutually different phases of the alternating current, expressed in radians, is preferably 7 k/M, where k is in each case an integer in the range from 1 to M−1.

Preferably, all feedthroughs through the reactor walls, i.e., in particular the tube inlet openings, the tube outlet openings and the (power) input openings are made gas-tight by means of suitable devices, such as a sealing bellows. Such a device for gas tightness is designed to be electrically insulating so that there is no electrical contact between the component being fed through and the respective reactor wall. If cooling panels arranged in a connection chamber are provided, a gas-tight design of the input openings can be dispensed with. The connection chamber should then be gas-tight with respect to the environment. This embodiment is helpful, for example, when it is difficult to seal elongate input openings (in order to absorb a longitudinal movement due to the thermal expansions of the reaction tubes). In this embodiment, the tube inlet and the tube outlet openings should be gas-tight.

Preferably, a ratio of the two distances of a power input arrangement to the two bridges is in the range from 0.25 to 1. More preferably, the ratio of the two distances is in the range from 0.25 to 0.8, preferably in the range from 0.25 to 0.7. The contact point, i.e., the point at which the power input arrangement is connected to the reaction tube, can therefore be arranged asymmetrically with respect to the bridges. In other words, in such an embodiment, the contact point divides the section of the reaction tube located between the two bridges into two tube sections of different lengths. This permits different heat input in the two tube sections and thus improved process control.

The chemical reaction can be a chemical reaction that proceeds at least partially at a temperature in the range of 200° C. to 1700° C., in particular of 300° C. to 1400° C. or of 400° C. to 1100° C. The chemical reaction is preferably a chemical reaction that proceeds at least partially at a temperature of at least 500° C., more preferably of at least 700° C., in particular at least partially in a temperature range of 500° C. or 700° C. to 1100° C. The provided electrical voltages/currents are suitable for providing corresponding heating powers. The reactor and the power source are likewise configured to carry out chemical reactions at these temperatures and to provide corresponding heating powers. The chemical reaction is preferably one of the following: steam cracking, steam reforming, dry reforming (carbon dioxide reforming), propane dehydrogenation, generally reactions with hydrocarbons that are carried out at least in part at over 500° C.

According to the invention, a method is proposed for carrying out a chemical reaction in a process fluid that proceeds at least in part at a temperature of at least 500° C., wherein a reactor as described herein is used, wherein the process fluid is conducted through the reaction tubes of the reactor and is heated by means of electrical resistance heating using multi-phase alternating current, wherein the chemical reaction is preferably one of the following reactions: steam cracking, steam reforming, dry reforming, propane dehydrogenation, a reaction with hydrocarbons, which is carried out at least in part at more than 500° C.

The invention is described below with reference to reaction tubes and reactors as used for steam cracking or for steam reforming. However, the invention may also be used in other reactor types. Generally, as mentioned, the reactor proposed according to the invention can be used for carrying out all endothermic chemical reactions.

The invention is explained in more detail below with reference to the accompanying drawings, which illustrate embodiments of the invention. In the figures, elements corresponding structurally or functionally to one another are indicated by identical or similar reference signs and, for the sake of clarity, are not explained repeatedly. Where elements appear repeatedly, in part only one of them is representatively provided with a reference sign.

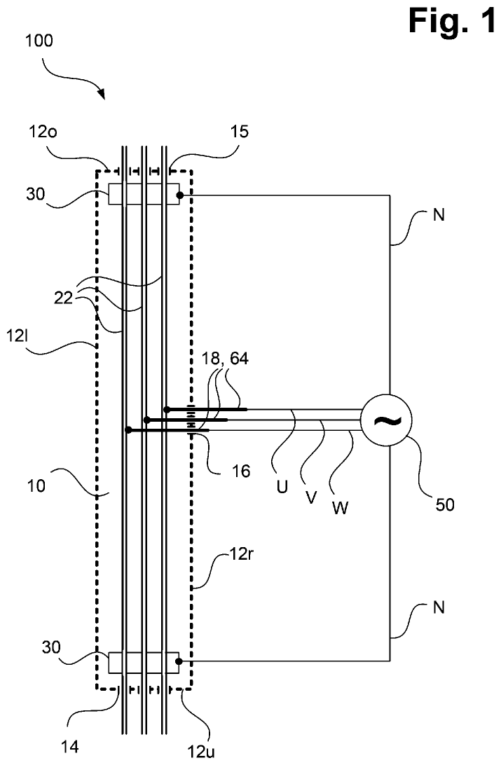

FIG. 1 shows a reactor 100 according to the invention according to a preferred embodiment. The reactor comprises reactor walls 12o, 12u, 12r, 121 which surround a reactor chamber 10, the reactor walls thus forming a reactor vessel (or a reactor box), the interior of which constitutes the reactor chamber. Furthermore, the reactor comprises multiple reaction tubes 22 which run in a straight line through the reactor chamber 10, wherein they run between tube inlet openings 14 and tube outlet openings 15 which are formed in the lower reactor wall 12u or the upper reactor wall 12o. In addition, collecting lines referred to as inlet headers or outlet headers can be provided (not shown), which fluidically connect the reaction tubes to one another on the inlet side or outlet side. This inlet header or outlet header may be arranged outside the reactor chamber, i.e., on the side of the reactor walls facing away from the reactor chamber, or in the reactor chamber. In the latter case, they are each arranged between one of the bridges and the closest reactor wall along the reaction tubes.

Each of the reaction tubes 22 is connected in an electrically conductive manner to a power input arrangement 18 which extends through an input opening 16 in a lateral reactor wall 12r. For this purpose, corresponding contact passages can be provided on the reaction tubes, which are electrically conductively connected to rod-shaped elements 64 which are comprised in the power input arrangements and which serve as live (electrically conductive) elements. The rod-shaped elements 64 extend through the reactor wall. The power input arrangements are in turn connected to the phases or phase connections U, V, W, a multiphase alternating current source 50, so that one of the phases is fed into each reaction tube. As shown, the alternating current source preferably has three phases and is the number of reaction tubes 3 or a multiple thereof, e.g., N 3, wherein N is an integer greater than or equal to 2, wherein each of the phases is connected via a respective power input arrangement to one of the reaction tubes, or wherein, if the number of reaction tubes is a multiple N of 3, each phase is connected via respective power input arrangements to N reaction tubes. Of course, a number different to 3, not equal to 1, of phases and reaction tubes (or multiples thereof) is also conceivable. The contact point of the connection of the power input arrangements to the reaction tubes can be asymmetrical with respect to the bridges for at least one power input arrangement (for different power input arrangements independently of one another), i.e., can divide the tube section of the respective reaction tube located between the bridges asymmetrically (not shown).

In general, the number of phases is therefore M, where M is an integer greater than 1. The phase shifts between the phases are preferably selected such that the voltages or currents cancel one another out at a star point, i.e., the phase shift between two arbitrary phases can be expressed as a radian measure as 2π·k/M, or in degrees as 360°k/N, where k is an integer in the range of 1 to M−1. With three phases therefore 2π/3 or 4/3, corresponding to 120° or 240°. The phase difference between two successive phases is obtained with k=1, i.e., as 2π/M. This selection is advantageous since the alternating voltages of the various phases at the bridges cancel each other out when the phases are loaded symmetrically.

The alternating current source 50 is shown primarily to provide an understanding the invention to illustrate how the multi-phase alternating current can be provided; it does not form any necessary part of the invention. This can be provided, for example, by a production plant in which reactor is to be installed or is installed.

A suitable alternating current source 50 can be executed as follows, for example as an alternating current transformer, in particular as a high-current transformer. The primary side, i.e., the alternating current supply to the alternating current source 50, is carried out, for example, from a public supply network or a generator. A primary-side alternating voltage can typically be a few hundred to a few thousand volts, e.g., 400 V, 690 V or 1.2 kV. Between the primary side of the power source 50 and a possibly public supply network or a generator, at least one further transformer (possibly at least one regulating transformer that makes it possible to control the secondary-side AC voltage or to adjust it within a certain voltage range) may be interposed in order to obtain a suitable input voltage for the high-current transformer. Instead of or in addition to this interposed, at least one transformer, the input voltage or the resulting heating output can also be set by means of one or more thyristor power controllers. On the secondary side, phase lines or phase terminals U, V, W are provided, on which the phases of the alternating current are provided. The secondary-side alternating voltage can expediently lie in the range up to 300 V, for example less than 150 V or less than 100 V, even less than or equal to 50 V. The secondary side is galvanically separated from the primary side.

Two electrically conductive bridges 30, which are electrically conductively connected to the reaction tubes 22, are provided in the reactor chamber 10, each bridge being connected here to all reaction tubes. The connection to the reaction tubes is effected at points which are spaced apart from one another along the reaction tubes, i.e., along the longitudinal direction thereof (i.e., the direction in which the process fluid can flow). In terms of circuitry, the bridges 30 form star points; they could therefore be referred to as star bridges. If a multiple N of the phase number M is present on reaction tubes (i.e., N M), two electrically conductive bridges spaced apart from one another can be provided for each of these multiples, each electrically conductive bridge being connected to M reaction tubes, or only two bridges that are spaced apart from one another can be provided, which are then each connected to all reaction tubes. Combinations are also conceivable.

The power input arrangements 18 or the live elements 64 thereof are connected to the reaction tubes between the two bridges 30. For example, here, approximately in the middle between the bridges. More generally, a distance ratio, i.e., the ratio of the two distances of a power input arrangement 18 to the two bridges 30 (more precisely the ratio of the smaller of these distances to the larger), should be in the range of 0.25 (a distance four times as large as the other) to 1 (distances equal in size). This ratio is preferably in the range from 0.5 to 1, more preferably in the range from 0.8 to 1. According to another preferred embodiment, this ratio is in the range from 0.25 to 0.8, more preferably in the range from 0.25 to 0.7. For different reaction tubes, this ratio can be different; it is preferably the same for all reaction tubes. Different distances of the power input arrangements to the bridges (distance ratio not equal to one) result in currents of different strengths and thus in different heating power inputs into the two tube sections between the power input arrangement and the two bridges. This may be used to influence the chemical reaction.

The bridges 30 are advantageously designed such that their electrical resistance is small compared to the reaction tubes. This is to be understood in the sense that the electrical resistance between two reaction tubes measured via a bridge is smaller than the electrical resistance of a section or comparison section of the reaction tubes having a certain length, wherein the electrical resistance is determined (calculated and/or measured) along the length. The electrical resistance of the comparison section forms a comparator resistance. In this case, one of the following comparison sections is preferably used: a comparison section having a length equal to the distance of the two reaction tubes; a comparison section having a length equal to a dimension of the bridge in the longitudinal direction of the reaction tubes; a comparison section having a length equal to a length of a reaction tube connection between an inlet header or outlet header and a bridge connection at the inlet or outlet of the tube; or a comparison section having a length equal to a distance of the bridge to a reactor wall in which the tube inlet or tube outlet openings are located, wherein the bridge is situated between this reactor wall and the connection points of the power input arrangements with the reaction tubes. A ratio between the electrical resistance measured via the bridge and the electrical resistance of the comparison section is preferably at most 1/10, more preferably at most 1/50, most preferably at most 1/100.

Furthermore, optional neutral conductors N are shown which connect the bridges to a star point of the power source. The neutral conductors are advantageously designed such that their electrical resistance (between bridge and current source) is greater than the electrical resistance of the bridges between two reaction tubes and smaller than the electrical resistance of the above comparison section.

The bridges can in principle be components which have passages for the reaction tubes. A contact between reaction tubes running through these passages and the bridges can then be produced, for example, by means of a press fit. It is also possible to cast the reaction tubes into the bridges.

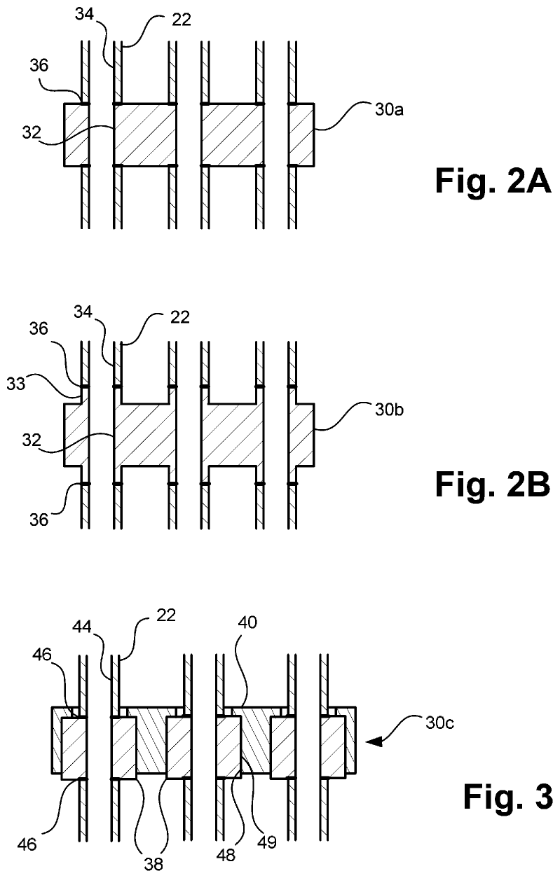

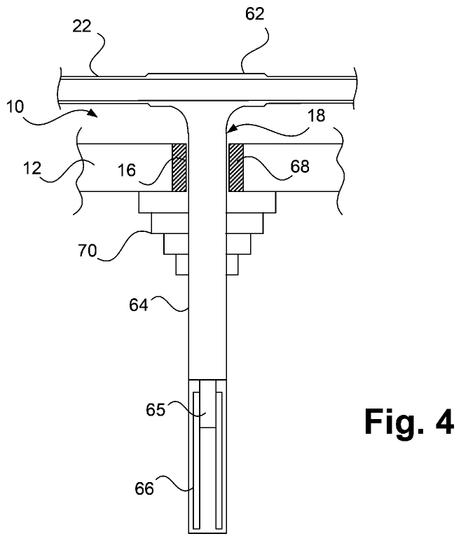

Deviating from this, it is preferably provided that passages through the bridges themselves are sections of the reaction tubes; in other words, sections of the reaction tubes are formed integrally with the bridges. The further reaction tube sections are then connected to these sections by welding. Corresponding embodiments are shown in FIGS. 2A, 2B and 3.

FIGS. 2A and 2B show, in a cross-sectional view, one-piece bridges 30a, 30b and their connection to reaction tubes 22 according to preferred embodiments. In FIG. 2A, the bridge 30a is formed by a plate through which passages 32 extend in the longitudinal direction. The side surfaces of the bridge or plate, which are opposite one another in the longitudinal direction, are flat, thus forming, with the exception of the passages, planes without projections. The geometry and dimensions of the passages 32 correspond to or are similar to the geometry and dimension of the inner side 34 of the reaction tubes 22. In the case of reaction tubes that are rotationally symmetrical about the longitudinal axis, the passages are thus circular, with their diameter being equal to the inner diameter of the reaction tubes. The bridge is connected by welding, i.e., by weld seams 36, to the reaction tube sections located outside the bridge, so that the passages 32 run flush with the inner sides 34. The passages 32 thus form sections of the reaction tubes.

The embodiment of FIG. 2B substantially resembles the embodiment of FIG. 2A, with the difference that projections 33 are provided here on the side surfaces of the bridge 30b, the geometry and dimensions of said projections 33 being the same as the geometry and dimensions of the wall of the reaction tubes 22 (more precisely the reaction tube sections located outside the bridge). In the case of rotationally symmetrical reaction tubes, the inner and outer diameters of the projections are therefore the same as the inner and outer diameters of the reaction tubes. These projections extend the passages, so to speak, beyond the side surfaces. The reaction tube sections located outside the bridge are connected to end faces of the projections by weld seams 36.

FIG. 3 shows, in cross-sectional view, a preferred multipart bridge 30c. This comprises multiple first bridge elements 38 and a second bridge element 40 corresponding to the number of reaction tubes. Each of the first bridge elements 38 has a passage 42 in the longitudinal direction, which is similar in its geometry and its dimensions to the geometry and dimension of the inner side 44 of one of the reaction tubes 22. Reaction tube sections outside the bridge 32c are connected to the respective first bridge element 38 by means of welding (weld seams 46) such that the passage is aligned therewith. The outer side 48 of the first bridge elements runs parallel to the longitudinal direction. A radial thickness of the first bridge elements, i.e., a distance between the passage and the outer side of the bridge elements, is preferably constant in the circumferential direction. Radial direction and circumferential direction are to be understood in relation to the longitudinal direction defined by the reaction tubes. Deviating from this, the outer side can also have a different geometry.

The second bridge element 40, which here, for example, is substantially a plate, has stepped passages 49 extending in the longitudinal direction, wherein a region (one step) of the passages is adapted in terms of its geometry and its dimensions to the outer side of the first bridge elements such that the first bridge elements can be inserted into these regions by means of a fit, in particular a press fit. A further region (other step) of the passages has a geometry and dimensions which are configured such that, on the one hand, the reaction tube section welded to the respective first bridge element fits through this region, and, on the other hand, the respective first bridge element does not fit through. The second bridge element can thus rest on the first bridge elements in the arrangement shown and is thus secured even if there is no press fit.

Preferably, the second bridge element consists of a material that is different from the material of the first bridge elements. Further preferably, the material of the second bridge element (e.g., molybdenum or a molybdenum alloy) has a higher electrical conductivity and a lower coefficient of thermal expansion than the material of the first bridge elements (e.g., a high-temperature-resistant Cr—Ni steel).

The first bridge elements could also be designed analogously to FIG. 2B (not shown), i.e., projections could be provided which extend the passages and which are the same in terms of their geometry and dimensions as the wall of the reaction tubes. The reaction tube sections outside the bridge are then again welded to the end faces of the projections. It is likewise possible for the reaction tubes to be cast into the first bridge elements.

Instead of multiple first bridge elements, a single first bridge element can also be used, which is tensioned (and connected to the latter) via the multiple reaction tubes and is connected to a single second bridge element. Referring to FIG. 3, the first bridge elements could be connected at their lower end to an individual first bridge element, such that this individual first bridge element can continue to be fitted into the second bridge element as shown. It is thus possible to ensure that a minimum potential equalization can take place via the first bridge element, even in the cold state, with possibly reduced contact between the two (first and second) bridge elements, which is further improved with increasing temperature and improved contact with the second bridge element.

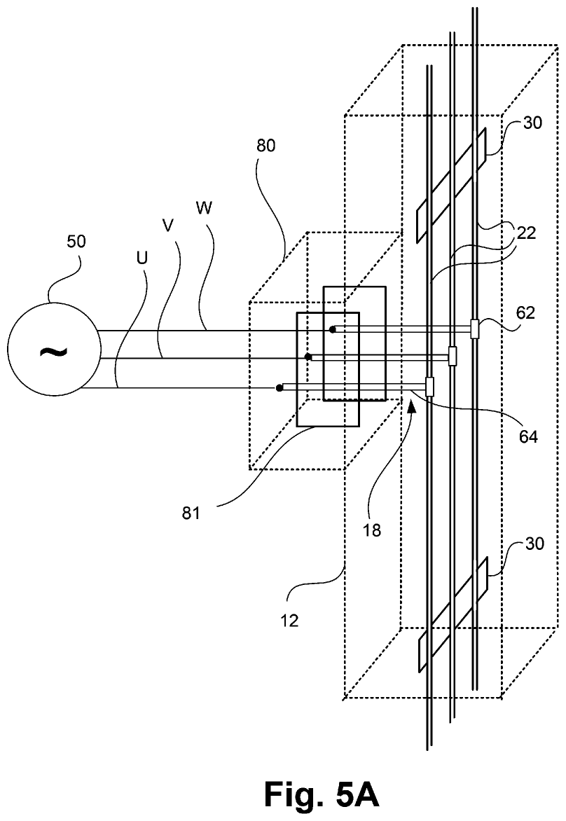

FIG. 4 schematically shows an exemplary power input arrangement 18 which is connected to a reaction tube 22 extending through a reactor chamber 10. The power input arrangement 18 comprises an electrically conductive rod-shaped element 64 which extends through an input opening 16 in a reactor wall 12 (for example the reactor wall 12r from FIG. 1). The input opening 16 is preferably lined with an electrical insulation material 68.

The power input arrangement 18 is electrically conductively connected to the reaction tube 22 in a contact passage 62. As shown, this is preferably designed as a thickening of the reaction tube, wherein the rod-shaped element 64 is formed integrally with the thickening, that is to say is integrally connected to the reaction tube. During manufacture, for example, the contact passage 62 and the rod-shaped element 64 can be manufactured as a one-piece cast part and can then be connected to the reaction tube by welding. As an alternative to the one-piece embodiment, the power input arrangement could also be connected to the latter by means of a collar which runs around the reaction tube. The rod-shaped element 64 transitions into a power input pin 65, on which, for example, two bus bars or strands 66 for connecting one of the phases (for instance U, V, W in FIG. 1) of a multiphase alternating current source are attached.

Furthermore, a bellows arrangement 70 can optionally be provided which ensures a gas-tight sealing of the reactor chamber 10 with respect to the environment and at the same time a mobility (for example for thermal equalization movements) of the rod-shaped elements 64 relative to the reactor wall 12.

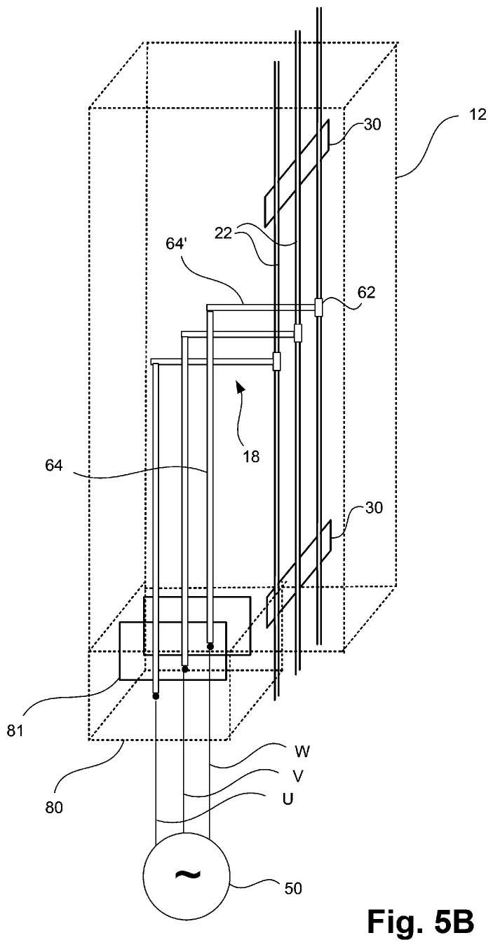

FIGS. 5A and 5B schematically depict preferred embodiments in which a cooling arrangement comprising cooling panels 81 is provided in each case for cooling the power input arrangements 18. The cooling arrangement is accommodated, for example, in a connection chamber 80 arranged outside the reactor chamber. In both cases, the arrangement of the reaction tubes 22 in the reactor chamber surrounded by the reactor wall 12 and the connection thereof to the bridges 30 and the power input arrangements 18 corresponds to that shown in FIG. 1. The reaction tubes are in each case electrically conductively connected in each case to the power input arrangements 18 on contact passages 62 (for instance with rod-shaped elements included therein, as in FIG. 4) and extend through one of the reactor walls, i.e., through input openings (not shown in further detail).

The cooling panels 81 accommodated in the connection chamber 80 are arranged so as to be adjacent to live elements of the input devices 18 (rod-shaped elements 64) and run parallel thereto. In particular, the panels are each located between two live elements or rod-shaped elements 64. In this way, heat conducted from the reactor by the input devices, and heat generated by electric currents in the input devices can be dissipated. Cooling fluid preferably flows through the cooling panels.

The two figures differ in that the input openings are arranged in different reactor walls and the input devices 18 or the rod-shaped elements 64 extend correspondingly through different reactor walls. In FIG. 5A, this is the left-hand reactor wall (in the figure). More generally a reactor wall extending parallel to the longitudinal direction defined by the reaction tubes could also be the right, the front or the rear reactor wall. The connection chamber 80 is arranged on the left-hand reactor wall outside the reactor chamber. The cooling panels 81 are arranged parallel to the longitudinal direction. A longitudinal movement of the input devices 18 in the longitudinal direction relative to the cooling panels 81, which are normally not movable, is thus possible. Such a longitudinal movement of the input devices, which are typically rigidly connected to the reaction tubes, can result from the thermal expansion of the reaction tubes. The support or suspension of the input devices is correspondingly preferably flexible, so that a longitudinal movement is possible. Each input opening should preferably have an elongated shape, i.e., its dimension in the longitudinal direction should be greater than its dimension transverse thereto, wherein both dimensions are to be understood parallel to the reactor wall. The left, right, front and rear reactor walls can generally be regarded as lateral reactor wall.

In FIG. 5B, the input devices, more precisely rod-shaped elements 64, are guided through the lower reactor wall, the upper reactor wall would likewise be possible. The rod-shaped elements 64 thus run parallel to the longitudinal direction. The input devices 18 here comprise further electrically conductive rod-shaped elements 64′ which are connected on the one hand to the rod-shaped elements 64, which run through the reactor wall, and on the other hand to the reaction tubes 22. These further rod-shaped elements 64′ here run parallel to the lower reactor wall, but also run obliquely. Here too, the input devices 18 are preferably flexibly supported or suspended.

As can be seen from the embodiments of FIGS. 5A and 5B, the present invention makes it possible to attach the input openings away from the inlet and outlet openings, so that live elements of the power input arrangements are not additionally heated by hot further process lines, and effective cooling of the power input arrangements is facilitated.

1. A reactor for carrying out a chemical reaction proceeding at least in part at a temperature of at least 500° C. in a process fluid using multiphase alternating current, the reactor comprising:
a reactor chamber surrounded by thermally insulating reactor walls; and
multiple substantially straight reaction tubes;
wherein:
the reaction tubes run between at least one tube inlet opening and at least one tube outlet opening opposite reactor walls through the reactor chamber and consist of a material that permits electrical resistance heating;
two electrically conductive bridges spaced apart from one another along the reaction tubes are provided in the reactor chamber, each of which electrically conductively connects the reaction tubes to one another; and
electrically conductive power input arrangements are provided extending through one or more input openings in one of the reactor walls, each reaction tube being electrically conductively connected to one of the power input arrangements, each power input arrangement being electrically conductively connected between the bridges to one of the reaction tubes and being connected or connectable to one of the phases of the alternating current.

2. The reactor according to claim 1, wherein;
an electrical resistance of each of the bridges between two reaction tubes is less than an electrical comparator resistance;
the comparator resistance is equal to the electrical resistance of one of the reaction tubes over a comparative length;
the comparison length is selected from the list consisting of: a distance of the two reaction tubes, and a length of a reaction tube connection between an entry and exit header and a bridge connection at the inlet or outlet of the tube; and
a ratio of the resistance of the bridge to the comparator resistance is not more than 1/10.

3. The reactor according to claim 1, wherein:
the bridges consist of the same material as the reaction tubes or a material with higher electrical conductivity than the reaction tubes; and/or
a cross-sectional area of the bridges lying between two reaction tubes, extending parallel to the reaction tubes and perpendicular to the plane formed by the two reaction tubes, is greater than a cross-sectional area of a wall of the reaction tubes perpendicular to the longitudinal axis of the tube.

4. The reactor according to claim 1, wherein:
the reaction tubes are cast in at least one of the bridges, and/or for at least one of the bridges a reaction tube section is formed integrally with the bridge or an element of the bridge for each reaction tube; and
further reaction tube sections are connected to the bridge by welding.

5. The reactor according to claim 1, wherein:
at least one bridge comprises first bridge elements, each of which is electrically conductively connected to one of the reaction tubes, and a second bridge element electrically conductively connects the first bridge elements,
the second bridge element consists of a material having a higher electrical conductivity than a material from which the first bridge elements are made; and
the first bridge elements are made of the same material as the reaction tubes.

6. The reactor according to claim 5, wherein the second bridge element has stepped passages through which the reaction tubes run and into which the first bridge elements are inserted in the form of a press fit.

7. The reactor according to claim 6, wherein:
the material of the second bridge element has a lower coefficient of thermal expansion than the material of the first bridge elements; and
the second bridge element consists predominantly or completely of molybdenum, tungsten, tantalum, niobium and/or chromium- and/or the first bridge elements consist of the material of the reaction tubes.

8. The reactor according to claim 1, wherein the bridges are designed as rigid components or assemblies, and wherein at least one of the bridges is designed in one piece, in particular as a cast part.

9. The reactor according to claim 1, wherein the one or more input openings are located in a reactor wall, which extends between the reactor walls in which the at least one tube inlet opening or the at least one tube outlet opening is located.

10. The reactor according to claim 9, wherein the one or more input openings have an elongated shape parallel to the longitudinal direction of the reaction tubes.

11. The reactor according to claim 1, wherein cooling panels, which are arranged adjacent to live elements of the power input arrangements, are provided outside the reactor chamber, wherein the cooling panels extend parallel to the longitudinal direction of the reaction tubes.

12. The reactor according to claim 1, wherein the one or more input openings are spatially separated from the at least one tube inlet opening and from the at least one tube outlet opening.

13. The reactor according to claim 1, further comprising an alternating current source providing the alternating current.

14. The reactor according to claim 13, wherein:
for at least one bridge, a neutral conductor is provided, which connects the bridge to a star point of the alternating current source;
an electrical resistance of the bridges between two reaction tubes is smaller than the electrical resistance of the neutral conductor connected to the respective bridge; and
a ratio of these resistances is at most 1/5.

15. The reactor according to claim 20, the electrical resistance of the neutral conductor is less than the comparator resistance.

16. The reactor according to claim 1, wherein a phase shift between two mutually different phases of the alternating current, expressed in radians, is 2π·k/M, where k is in each case an integer in the range from 1 to M−1.

17. The reactor according to claim 1, wherein a ratio of the two distances of a power input arrangement to the two bridges is in the range of 0.25 to 1.

18. The reactor according to claim 17, wherein the ratio of the two distances is in the range from 0.25 to 0.8.

19. A method for carrying out a chemical reaction in a process fluid that proceeds at least in part at a temperature of at least 500° C., wherein a reactor according to claim 1 is used, wherein the process fluid is conducted through the reaction tubes of the reactor and is heated by means of electrical resistance heating using multi-phase alternating current, wherein the chemical reaction is selected from the list consisting of: steam cracking, steam reforming, dry reforming, propane dehydrogenation, and reaction with hydrocarbons, which is carried out at least in part at more than 500° C.

20. The reactor according to claim 2, further comprising an alternating current source providing the alternating current;
wherein:
for at least one bridge, a neutral conductor is provided, which connects the bridge to a star point of the alternating current source;
an electrical resistance of the bridges between two reaction tubes is smaller than the electrical resistance of the neutral conductor connected to the respective bridge; and
a ratio of these resistances is at most 1/5.
